(19) United States
(12) Patent Application Publication
(10) Pub. No.: US 2004/0031325 A1
(43) Pub. Date: Feb. 19, 2004

(54) Method of operating a device exposed to ambient conditions and installation including such a device

(76) Inventor: David Lechtman, Vanderbijlpark (ZA)

Correspondence Address: Chernoff Vilhauer McClung & Stenzel, 1600 ODS Tower, 601 S W Second Avenue, Portland, OR, 97204-3157, US

(21) Appl. No.: 10/415,964

(22) PCT Filed: Nov. 6, 2001
(86) PCT No.: PCT/IB01/02071

(30) Foreign Application Priority Data
Nov. 6, 2000 (ZA) 2000/6326
Jan. 18, 2001 (ZA) 2001-0499

(51) Int. Cl. G01L 1/00

(52) U.S. Cl. 73/766

(57) ABSTRACT

The invention relates to dealing with an effect of ambient conditions on operation of an installation in response to a physical action. By way of example, when the installation is a measuring installation, master circuitry (12) is used in measuring a physical action. Control circuitry (32) matching the master circuitry is isolated from the physical action. The master and control circuitry, in close physical relationship, are similarly subjected to ambient conditions. An actual output and an expected output f the control circuitry are compared and a discrepancy is detected. The output of the master circuitry (12) is modified in accordance with said discrepancy, for example to compensate for the effect of the ambient conditions, or to cancel recorded n of an erroneous measurement.

THIS INVENTION relates to responding to a physical action under operating ambient conditions which are not controlled or are not fully controlled. It relates more specifically to a method of operating a master device exposed to ambient conditions and to an installation including a master device exposed to ambient conditions.

It is to be appreciated that ambient conditions under which devices operate can frequently be controlled to a limited extend or that one or a few of the conditions (but not all of the conditions) can be controlled. The Applicant has realized this and this invention relates to a method and an installation of dealing with an effect of ambient conditions on operating of a device.

The operation of a device exposed to ambient conditions may be compromised if such ambient conditions are adverse. There is a number of such conditions, the most easily recognised being temperature. Thus, if the device is exposed to sunlight, its temperature may rise to a temperature well above a temperature of the environment. Likewise, even if the device is not so exposed, but is in heat exchange relationship with a heat conductive body which is so exposed, then also its temperature may rise to a value well above the temperature of the environment. There are also other factors beside temperature which can negatively affect the operation of th device. Factors such as transient of temporary magnetic fields, earth tremors, mechanical shock, wind, geomagnetically induced currents (GIC), strong electromagnetic radiation, strong pulse rader beams, electrostatic fields, magnetic storms arising from sun spot activity, and the like, may effect operation of the device.

In accordance with a first aspect of this invention, in operating a master device, which is exposed to operating ambient conditions, in response to a physical action to which the master device is subjected, there is provided the method of

providing a control device similar to the master device, of which an operation is predetermined under predetermined ambient conditions;

exposing the control device similarly to said operating ambient conditions and isolating the control device from the physical action;

monitoring operation of the control device and comparing said operation with said predetermined operation and monitoring or detecting any discrepancy;

influencing said operation of the master device in accordance with said discrepancy.

In one kind of method, said influencing said operation of the master device may be to cancel an effect of said operation when said discrepancy is beyond a predetermined limit. Said predetermined limit may be constant. Instead, said predetermined limit may be set in relation to operation of the master device.

The method may include activating an alarm when said discrepancy is beyond said predetermined limit.

In another kind of meth d, said influencing said operation of the master device may include modifying said operation of the master device to compensate for the effect of the operating ambient conditions.

In one species of the method of the invention, the master device may be a measuring device and operation thereof may be to measure said physical action. The method may include the step of subtracting said discrepancy, in a predetermined ratio, from an output of the master device. Thus, if the master device and the control device are matched on a 1:1 basis, said predetermined ratio may be 1. If the control device is matched to the master circuitry at a predetermined scale, said ratio may be the inverse of said scale.

In another species of the method of the invention, the master device may be a control device and operation thereof may be to control a physical operation. Controlling a physical operation may be in respect of widely diverging physical operations, such as industrial processes, navigation of aircraft, traffic control, mechanical operations, and the like.

Generally, the master device may be one of an electronic device, an electric device, a mechanical device, a combination of two or more of an electronic device, an electric device, a mechanical device.

In accordance with a second aspect of this invention, there is provided an installation comprising a master device which is exposed to operating ambient conditions, and which is adapted to operate in response to a physical action to which it is subjected in use;

a control device which is similar to the master device and which is similarly exposed to said operating ambient conditions and which is isolated from said physical action and whose operation is predetermined under predetermined operating conditions;

a monitor arranged to monitor operation of the control device and to monitor or detect any discrepancy between said operation and said predetermined operation of the control device.

In one kind of installation, it may include a modifier arranged to modify operation of the master device in accordance with said discrepancy. The modifier may be adapted to cancel an effect of operation of the master device when said discrepancy is beyond a predetermined limit. Said predetermined limit may be constant. Instead, said predetermined limit may be set in relation to operation of the master device. By way of development, the installation may include an alarm arranged to be actuated when said discrepancy is beyond said predetermined limit.

In another kind of installation, the modifier may be arranged to modify operation of the master device to compensate for influence of the operating ambient conditions.

The master device may be an electronic, an electric, a mechanical device, or a combination of an electronic, an electric or a mechanical device.

In one species of installation, the master device may be a measuring device measuring said physical action. In one application, the master device may include a load cell for m asuring a load. Then, the installation may be in the form of a vehicle load measuring station including a platform to support a vehicle, the master device being arranged to measure the mass on the platform, the control device being isolated from the mass on the platform. The master device and the control device may be arranged in casings, the casings being in heat exchange relationship with each other.

In another species of installation, the master device may be a control device for controlling a physical operation.

The invention is now described by way of examples with reference to the accompanying diagrammatic drawings.

In the drawings,

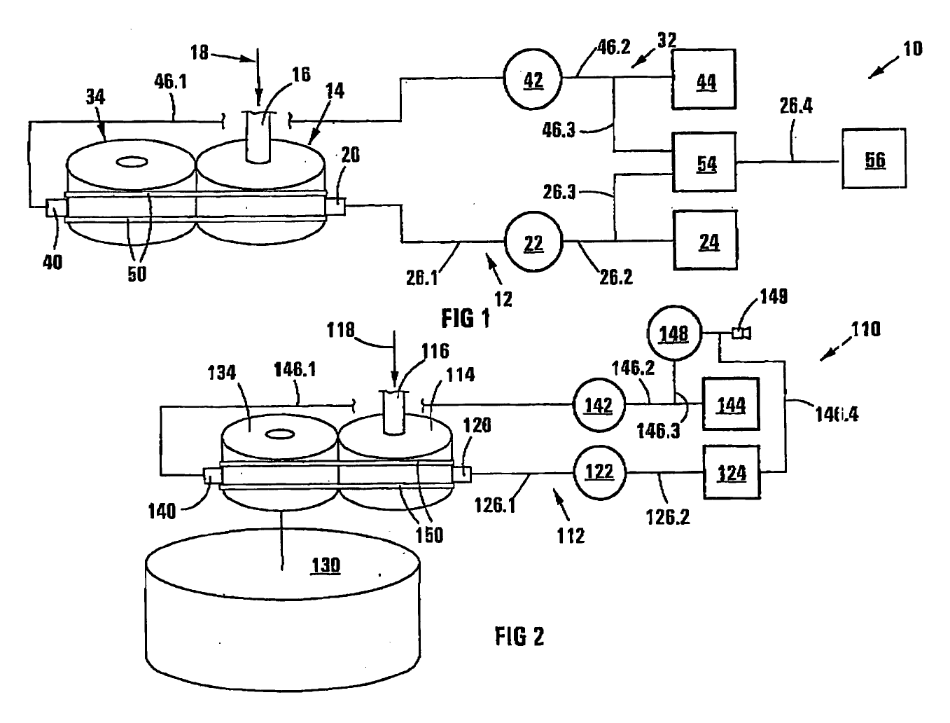

FIGS. 1 and 2 show, schematically, two similar installations in the form of measuring installations in accordance with the invention;

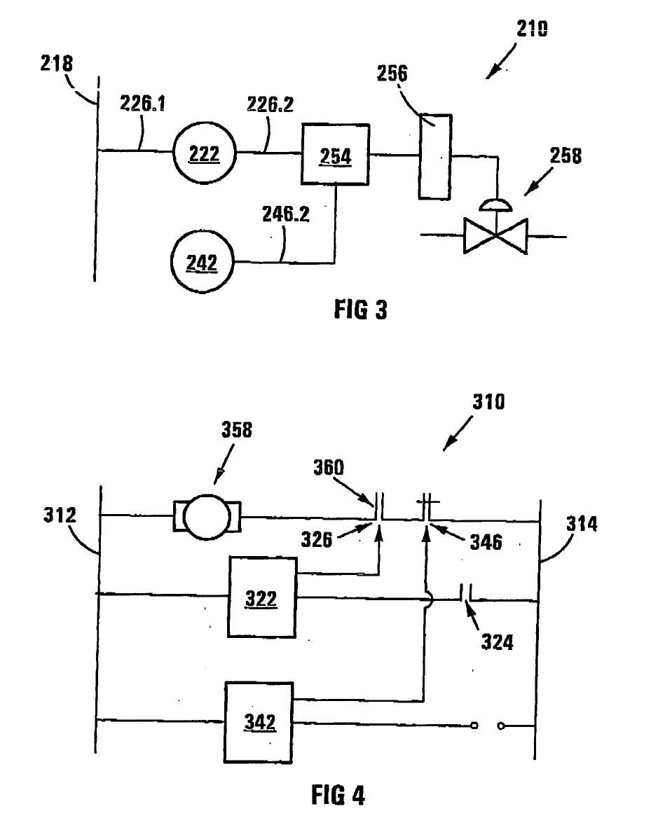

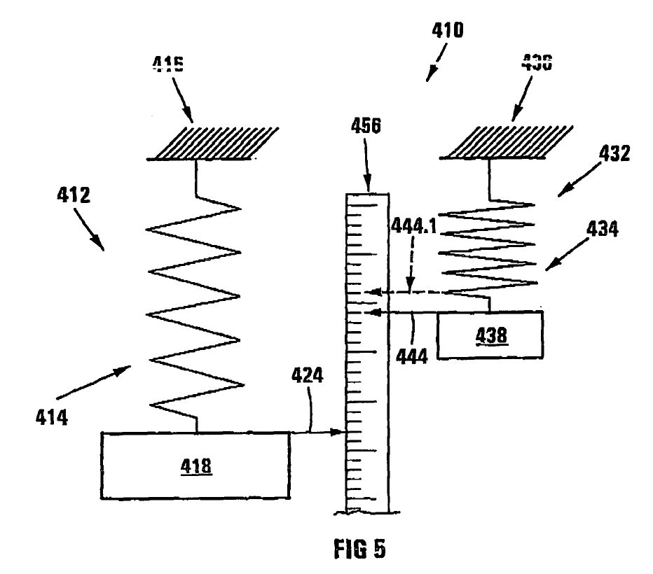

FIGS. 3 and 4 show, schematically, two further installations in the form of control installations in accordance with the invention; and

FIG. 5 shows, schematically, a mechanical measuring installation in accordance with the invention.

With reference to FIG. 1 of the drawings, a first embodiment of an installation in the form of a measuring installation in accordance with the invention is generally indicated by reference numeral 10. The measuring installation 10 is suitable for measuring the load on a load platform, for example a load platform for measuring the mass of vehicles.

The measuring installation 10 includes a master device in the form of master circuitry generally indicated by references numeral 12 and which includes a load cell indicated by reference numeral 14 to which a load represented by an arrow 18 is applied via a load transmission member 16. The load 18 would, for example, be generated by a mass of a vehicle on the load platform.

The load cell 14 has an output 20 via which an output signal is transmitted by means of a signal transmission line 26 (present in sections denoted by sub-numerals) and a transmitter 22 to a recorder 24. The recorder 24 thus records the data representative of the load 18.

The measuring installation 10 further comprises a control device in the form of control circuitry 32 comprising components similar to, preferably identical to, those of the master circuitry 12, and like reference numerals are used to denote like components or features. Thus, the control circuitry 32 comprises a load cell 34 having an output 40 via which an output signal is transmitted by means of a conductor 46 (present in sections denoted by sub-numerals) via a transmitter 42 to a recorder 44.

The load cells 14, 34 are in close physical proximity and are further interconnected by means of straps 50 further to ensure that the load cells are subjected similarly to the environmental or ambient conditions, such as temperature.

It is of particular significance that the load cell 34 of the control circuitry is not subjected to the load 18, in fact it is not subjected to any load. Thus, the control circuitry 32, when operating under calibrated conditions, should have a predetermined, eg zero, output. However, because the ambient conditions change it is expected that there will be an output which is unequal to the predetermined output and which is caused by ambient conditions to which the control circuitry 32 is subjected. Thus, a discrepancy in the recorded result of the recorder 44 is purely due to discrepancies in the ambient conditions compared to the calibrated conditions under which the circuits were calibrated. Thus, the discrepancy in the result recorded by the recorder 44 is a direct indication of the measuring fault as a result of environmental or ambient conditions.

Thus, in accordance with the invention, the signals transmitted by the respective transmitters 22, 42 are directed to a comparator and modifier generally indicated by reference numeral 54 in which the result of the recorder 44 is compared with an expected result and the result of the recorder 24 is modified in a predetermined fashion and is then recorded by means of a recorder 56 which will then show the actual or corrected load 18.

With reference to FIG. 2, a similar measuring installation is generally indicated by reference numeral 110. Many components and features of the installation 110 are similar to or identical to those of the measuring installation 10, they are denoted by like reference numerals and they are not again described. Emphasis will merely be placed on developments or changes of the measuring installation 110 over the measuring installation 10.

A first development is to apply a constant, known mass 130 to the load cell 134 such that the output of the load cell 134, in ideal or calibrated conditions, will be representative of the mass 130. A signal generator 148 is introduced into the control circuitry 132 to compare the mass measured by the load cell 134 to the actual mass of the mass 130. It is to be appreciated that a variation in, e.g., temperature causes a change in the elastic modulus of the components subjected to stress, notably the body of the load cell. This causes a discrepancy or error in the load measured in comparison to the actual load. If a discrepancy more than a predetermined value is detected, an alarm 149 is actuated to warn an operator that the measuring installation 110 has moved out of acceptable operating limits. Further by way of development, the signal generated by the signal generator 148 can be relayed to the recorder 124 to prevent recordal of a figure for the mass 118 lest an erroneous figure outside of predetermined limits be recorded.

It is important to appreciate that the control circuitry operates or measures in the same units as the master circuitry.

In FIG. 3, a control installation 210 performs a control operation in response to pressure in a pipeline 218 which is measured by means of a sensor which is not shown, and which transmits an output signal via a conductor 226.1 to a pressure transmitter 222, which, in turn, transmits a signal via a conductor 226.2 and a comparator and modifier 254 to a controller 256 to control a valve 258.

In accordance with the invention, a pressure transmitter 242 identical to the pressure transmitter 222 is placed in close proximity to the pressure transmitter 222. The pressure transmitter 242 is not subjected to pressure in the pipeline 218 or to an output signal from the pressure sensor. The pressure transmitters 222 and 242 are similarly or equally subjected to environmental or ambient conditions by being in close physical proximity. Thus, in conditions identical to calibrated conditions, the output of the pressure transmitter 242 will be predetermined. However, in use, environmental or ambient conditions, such as magnetic fields, geomagnetically induced current, electromagnetic radiation, and the like may influence the operation of the pressure transmitters 222 and 242 and may thus cause a discrepancy in the output of the pressure transmitter 242, which is conducted as shown at 246.2 to the comparator and modifier 254. The comparator and modifier 254 is preprogrammed to compare the output signal from the pressure transmitters 242 with a predetermined value and to modify the output from the pressure transmitter 222 in accordance with any such discrepancy to cancel or compensate for the effect of environmental or ambient conditions. The controller 256 thus receives a corrected or compensated signal and operates the valve 258 in accordance with an actual value of the pressure in the pipeline 218.

With reference to FIG. 4, a control installation is generally indicated by reference numeral 310. An electrical motor representing an electrical apparatus is generally indicated by reference numeral 358. It is powered from conductors 312, 314.

The motor 358 is actuated by closing of contactors 360 by means of a relay 322 which is actuated via a switch 324 to transmit power as indicated by reference numeral 326 to the contactor 360.

However, the relay 322 may be subjected to mechanical or other shock or influence which may cause it to generate the signal to clos the contactors 360 erroneously. To guard against such an eventuality, there is provided a normally closed set of contactors 362 in series with the contractors 360, and a control relay 342 in close physical proximity to the relay 322 to be subjected to the same environmental conditions i.e. shock or other load. The arrangement is such that in the event that the relay 322, because of uncontrollable and undesired outside influence closes the contactors 360, the relay 342, which will be identically influenced by such shock or outside influence, will cause cancellation of the erroneous effect by means of a signal transmitted to the normally closed contactors 362 to open such contactors 362 and thus to ensure that the electrical motor 358 is not erroneously activated.

It is an advantage of the invention that a simple, elegant control device is provided in an installation, which control device, with high integrity, cancels or compensates for undue ambient or environmental influence.

With reference to FIG. 5, an installation in accordance with the invention in the form of a mechanical weighing installation is generally indicated by reference numeral 410. A master device 412 comprises a mechanical resilient element in the form of a spring 414 which is anchored at 416, a pointer 424 and a scale 456. A mass 418 is suspended via the spring 414 and resiliently strains the spring 414 proportionally to its weight. The pointer 424 indicates the weight of the mass on the scale 456. Under adverse ambient conditions, especially extreme temperature, the modulus of elasticity and in fact also the length of the spring are influenced, and the reading of the pointer 424 is in error.

In accordance with the invention, a similar control device 432 suspends a known mass 438 causing, under predetermined conditions, strain of the spring 434 and a weight reading to be taken at a position of the pointer 444.1, shown in chain-dot lines. Under actual or operating ambient conditions, a different reading is shown by the printer 444 in solid lines. The discrepancy between the readings is caused by a change in the ambient conditions. The master device 412 is similarly influenced by the ambient conditions, and the reading of the pointer 424 is corrected in accordance with the discrepancy in the proportion of the values of the masses 438, 418 to compensate for the influence of the ambient conditions.

1. A method of measuring a quantity of a physical action, including
in a master device which includes a sensor, a transmission line for transmitting a signal from the sensor, and a recorder for recording an output of the sensor in a predetermined measuring unit, subjecting the sensor to the physical action, the master device being exposed to ambient conditions, and recording the quantity of the physical action in said predetermined measuring unit;
in a control device which includes a control sensor, a control transmission line for transmitting a signal from the control sensor, and a control recorder for recording an output of the control sensor, isolating the control sensor from the physical action, the control device being exposed, similarly to the master device, to ambient conditions, and recording the output of the control sensor in said predetermined measuring unit;
comparing the recorded output of the control sensor with a predetermined output for the control sensor under predetermined ambient conditions and monitoring or detecting any discrepancy;
influencing operation of the master device in accordance with any said discrepancy.

2. A method as claimed in claim 1 in which influencing said operation of the master device is to cancel an effect of said operation when said discrepancy is beyond a predetermined limit.

3. A method as claimed in claim 2 in which said predetermined limit is constant.

4. A method as claimed in claim 2 in which said predetermined limit is set in relation to operation of the master device.

5. A method as claimed in any one of claim 2 to claim 4 inclusive which includes activating an alarm when said discrepancy is beyond said predetermined limit.

6. A method as claimed in claim 1 in which influencing said operation of the master device includes modifying said operation of the master device to compensate for the effect of the operating ambient conditions.

7. A method as claimed in any one of claim 1 to claim 6 inclusive in which the master device is one of an electronic device, an electric device, a mechanical device, a combination of two or more of an electronic device, an electric device, a mechanical device.

8. A measuring installation comprising
a master device which includes a sensor, a transmission line for transmitting a signal from the sensor, and a recorder for recording an output of the sensor in a predetermined measuring unit;
a control device which includes a control sensor, a control transmission line for transmitting a signal from the control sensor, and a control recorder for recording an output of the control sensor in said predetermined measuring unit, an operation of the control device being predetermined under predetermined operating conditions;
a monitor arranged to monitor operation of the control device under ambient conditions and to monitor or detect any discrepancy between an actual output of the control sensor under said ambient conditions and a predetermined output of the control sensor under predetermined ambient conditions.

9. An installation as claimed in claim 8 which includes a modifier arranged to modify operation of the master device in accordance with said discrepancy.

10. An installation as claimed in claim 9 in which the modifier is adapted to cancel an effect of operation of the master device when said discrepancy is beyond a predetermined limit.

11. An installation as claimed in claim 10 in which said predetermined limit is constant.

12. An installation as claimed in claim 10 in which said predetermined limit is set in relation to operation of the master device.

13. An installation as claimed in any one of claim 10 to claim 12 inclusive which includes an alarm arranged to be actuated when said discrepancy is beyond said predetermined limit.

14. An installation as claimed in any one of claim 8 to claim 13 inclusive in which the master device is one of an electronic, an electric, a mechanical device, or a combination of an electronic, an electric or a mechanical device.

15. An installation as claimed in claim 8 in which the master device includes a load cell for measuring a load.

16. An installation as claimed in claim 15 which is in the form of a vehicle load measuring station including a platform to support a vehicle, the master device being arranged to measure the mass on the platform, the control device being isolated from the mass on the platform.

17. An installation as claimed in claim 16 in which the master device and the control device are arranged in casings, the casings being in heat exchange relationship with each other.
